(19) United States
(12) Patent Application Publication
(10) Pub. No.: US 2024/0045050 A1
(43) Pub. Date: Feb. 8, 2024

(54) Method for Validating Environment Detection Sensors of a Vehicle and a Vehicle Configured for Validating Environment Detection Sensors

(71) Applicant: Daimler Truck AG, Leinfelden-Echterdingen (DE)

(72) Inventor: Sebastian KLEINSCHMIDT, Hannover (DE)

(21) Appl. No.: 18/256,849

(22) PCT Filed: Oct. 15, 2021
(86) PCT No.: PCT/EP2021/078572

§ 371 Date: Jun. 9, 2023

(30) Foreign Application Priority Data
Dec. 11, 2020 (DE) 10 2020 007 599.1

(51) Int. Cl. G01S 13/58; G01S 13/60; G01S 13/86

(52) U.S. Cl. CPC G01S 13/589; G01S 13/60; G01S 13/865; G01S 13/867

(57) ABSTRACT

A method for validating a plurality of environment detection sensors that are rigidly connected with a vehicle, where the plurality of environment detection sensors are configured for detecting a relative speed, which is based on a sensor coordinate system of a respective environment detection sensor, of an object detected in the vehicle environment. In an extrinsic calibration, a uniform coordinate transformation is defined for every sensor coordinate system. Using the uniform coordinate transformations: an object speed is defined for every relative speed based on the vehicle coordinate system and/or at least one parameter of a movement model of the vehicle is defined from the plurality of the relative speeds. A decalibrated state is then assigned to the plurality of environment detection sensors when the object speeds deviate from each other and/or relative to the movement model of the vehicle by more than a predetermined amount.

### BACKGROUND AND SUMMARY OF THE INVENTION

The invention relates to a method for validating an extrinsic calibration of a plurality of environment detection sensors that are rigidly connected with a vehicle, which sensors are configured for detecting a relative speed, which is respectively based on a sensor coordinate system. The invention further relates to a vehicle having such environment sensors and having at least one control unit.

A method for calibrating a sensor for measuring distances with two sensor channels, the radiation emission of which is lobe-shaped, is known from DE 10 2005 037 094 B3. The method comprises the following steps:
emitting a radiation lobe of a sensor channel onto a calibration surface by means of the sensor,
detecting the radiation lobe with a camera of a video system,
identifying a first representative value of the radiation lobe in image coordinates of the camera,
changing a location of the calibration surface in relation to the sensor and the camera,
detecting the radiation lobe with the camera,
identifying a second representative value of the radiation lobe in image coordinates of the camera,
repeating the preceding steps for a further sensor channel,
modelling lobe axes of the emitted radiation lobes as straight lines in sensor coordinates,
transforming the modelled straight lines from sensor coordinates into image coordinates of the camera,
comparing the straight lines with the identified representative values in image coordinates for every sensor channel,
identifying a calibration function for compensating a possible deviation of the modelled straight lines of at least several representative values.

The object of the invention is to provide a novel method for validating environment detection sensors of a vehicle. The object of the invention is further to provide a vehicle that is configured for validating such environment detection sensors.

In a method for validating a plurality of environment detection sensors that are rigidly connected with a vehicle, which sensors are configured for detecting a relative speed, which is respectively based on a sensor coordinate system, of at least one object in the environment of the vehicle, a uniform coordinate transformation for converting coordinates of the sensor coordinate system into coordinates of a vehicle coordinate system that is rigidly connected with the vehicle is defined according to the invention for every sensor coordinate system in an extrinsic calibration. The relative speed specifies, according to magnitude and direction, the movement speed of an object in the environment of the vehicle relative to the respective sensor coordinate system.

Using the uniform coordinate transformation associated with the respective sensor coordinate system, an object speed, based on the vehicle coordinate system, is defined for every relative speed detected by an environment detection sensor. The object speed specifies, according to magnitude and direction, the movement speed of an object in the environment of the vehicle relative to the vehicle coordinate system.

Alternatively or additionally to defining the object speeds, at least one parameter of a movement model of the vehicle is defined from the plurality of the relative speeds. A movement model of a vehicle can, for example, be specified as a current (instantaneous) vehicle speed according to magnitude and direction. Movement models are, however, also possible, in which other or additional parameters, for example at least one angular velocity or a radius of curvature of a trajectory driven by the vehicle, are detected.

From the plurality of environment detection sensors, a decalibrated state is then assigned if the object speeds defined based on the vehicle coordinate system deviate from each other by more than a predetermined amount.

A decalibrated state is to be understood here and in the following as a change of the position (i.e., the location and/or orientation) at least of a sensor coordinate system relative to at least one other sensor coordinate system compared to the position detected in the extrinsic calibration, wherein this change of the position means that the vehicle speed can no longer be validly identified from the relative speeds.

Alternatively or additionally, a decalibrated state is then assigned if the object speeds differ by more than a predetermined amount from the speeds which the objects in the surroundings of a vehicle have on the basis of a movement model of the vehicle defined from the relative speeds with at least one parameter.

An advantage of the method is that an extrinsic calibration can be validated if relative speeds of different objects are detected by different environment detection sensors. A validation of the extrinsic calibration is also in particular possible if the regions of the surroundings of a vehicle which are swept over by different environment detection sensors do not overlap. A validation is further possible without objects being identified, i.e., recognizing them as being detected as consistent by different environment detection sensors.

A validation according to the method according to the invention is additionally possible without access to a digital map in which objects are recorded, which can potentially be detected by an environment detection sensor. It is thereby possible to carry out a validation continuously and, in principle, of any, in particular also non-mapped environments.

The method according to the invention thus enables a more reliable and simpler validation of a plurality of environment detection sensors than methods known from the prior art.

In one embodiment of the invention, deviations between object speeds, which are associated with different sensor coordinate systems, are defined pairwise as vector differences. The maximum pairwise vector difference according to magnitude and/or direction is compared with a predetermined difference in magnitude (regarding the magnitude of the pairwise vector difference) or with a predetermined difference in angle (regarding the direction of the pairwise vector difference). A decalibrated state is then assigned to the plurality of environment detection sensors if at least one pairwise vector difference exceeds the predetermined amount regarding the difference in magnitude and/or the difference in angle.

An advantage of this embodiment is that a decalibrated state can be especially easily identified.

In one embodiment of the method, the movement model of the vehicle is defined as a vehicle speed based on the vehicle coordinate system, according to magnitude and direction. According to the respectively associated uniform coordinate transformation, a target relative speed is correspondingly identified for every sensor coordinate system from the vehicle speed. At least one target relative speed is compared with the relative speed detected for the respective sensor coordinate system according to magnitude and/or direction.

An advantage of this embodiment is that a decalibrated state can be identified especially reliably. In particular, very similar deviations of several sensor coordinate systems can be reliably recognized according to magnitude and direction.

In one embodiment, a reliability of the assignment of the decalibrated state is statistically identified from the plurality of the relative speeds. For example, a reliability can be identified from the relative proportion of the sensor coordinate systems, the associated object speeds of which do not deviate from each other, or only deviate slightly from each other, i.e.: by less than the predetermined amount.

Alternatively or additionally, a calibrated state can then be associated if the object speeds do not deviate from each other and regarding the movement model of the vehicle exclusively, or only deviate slightly from each other, i.e.: by less than the predetermined amount.

A calibrated state is to be understood here and in the following as meaning that the positions of all sensor coordinate systems compared to the position respectively identified in the extrinsic calibration do not differ or differ only so far that the vehicle speed can still be validly identified from the relative speeds.

In the same way as already explained for the reliability of the assignment of the decalibrated state, the reliability of the assignment of the calibrated state is also statistically identified.

An advantage of this embodiment of the method is that erroneous assignments of states can be recognized in the case of unreliable measurements of individual environment detection sensors, for example when detecting a vehicle driving in front by means of at least one environment detection sensor and simultaneously detecting a stationary object by means of at least one further environment detection sensor. A more robust and more fault-tolerant validation is thereby enabled.

In a vehicle comprising at least one computing unit and a plurality of environment detection sensors, which are configured for detecting a relative speed, with reference to a sensor coordinate system of the respective environment detection sensor, of at least one object detected in the surroundings of the vehicle, the environment detection sensors and the at least one computing unit are configured according to the invention for carrying out the method described for validating the plurality of the environment detection sensors.

Such a vehicle has the advantage that a decalibration of the environment detection sensors is recognized especially easily and reliably, and errors in vehicle functions which rely on an analysis of measurement data of these environment detection sensors, for example erroneous or missing warnings of the vehicle driver or an incorrect control of the vehicle, can be recognized or avoided. A more reliable and more secure vehicle is thereby enabled.

In an especially space- and cost-saving embodiment, the at least one computing unit is formed as a control unit.

Exemplary embodiments of the invention are illustrated in greater detail below by means of drawings.

### BRIEF DESCRIPTION OF THE DRAWINGS

FIG. 1 schematically shows a vehicle having sensors for measuring speeds in an arrangement for extrinsic calibration;

FIG. 2 schematically shows relative speeds and object speeds when the sensor position is unchanged compared to the extrinsic calibration;

FIG. 3 schematically shows a vehicle having sensors in a sensor position that is changed compared to the extrinsic calibration;

FIG. 4 schematically shows relative speeds and object speeds when the sensor position is changed compared to the extrinsic calibration;

FIG. 5 schematically shows the flowchart of a method for differentiating between a calibrated and a decalibrated state;

FIG. 6 schematically shows a vehicle having sensors in a sensor position that is unchanged compared to the extrinsic calibration when cornering; and

FIG. 7 schematically shows a vehicle having sensors in a sensor position that is unchanged compared to the extrinsic calibration when cornering.

### DETAILED DESCRIPTION OF THE DRAWINGS

Parts that correspond to one another are provided with the same reference numerals in all figures.

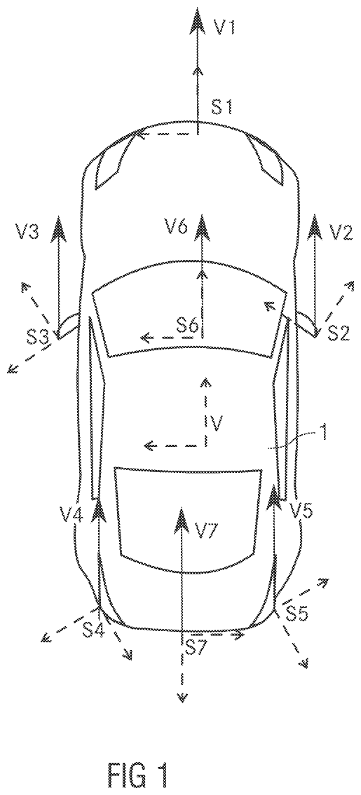

FIG. 1 shows a vehicle 1 which is provided with seven sensors that are not shown in more detail. Every sensor is configured to respectively measure a relative speed V1 to V7, respectively based on a sensor coordinate system S1 to S7 according to magnitude and direction.

Such sensors can, for example, be formed as a LIDAR or RADAR sensor or as a Time-of-Flight (ToF) camera. A relative speed V1 to V7 can also thereby be identified in that the distance of a vehicle-independent stationary object to the respective sensor coordinate system S1 to S7 is detected by means of a camera at successive measurement times and a relative speed V1 to V7 is calculated from the relative movement of the object in the sensor coordinate system S1 to S7, depending on the difference of the measurement times.

To simplify the representation, in FIG. 1, a first to seventh relative speed V1 to V7 are respectively shown in a two-dimensional cartesian sensor coordinate system S1 to S7. However, sensors are also available with which a relative speed V1 to V7 can be detected as a three-dimensional vector size. The method described in the following can also be carried out for three-dimensional detected relative speeds, without restriction.

The sensors are connected fixedly with each other by means of the vehicle 1 and follow its movement. The positional relationship of the sensor coordinate systems S1 to S7 to each other as well as in relation to a vehicle coordinate system V can thus be described by means of a uniform coordinate transformation. In particular, the second to fifth sensor coordinate system S2 to S5 as well as the seventh sensor coordinate system S7 are rotated relative to each other and compared to the vehicle coordinate system V.

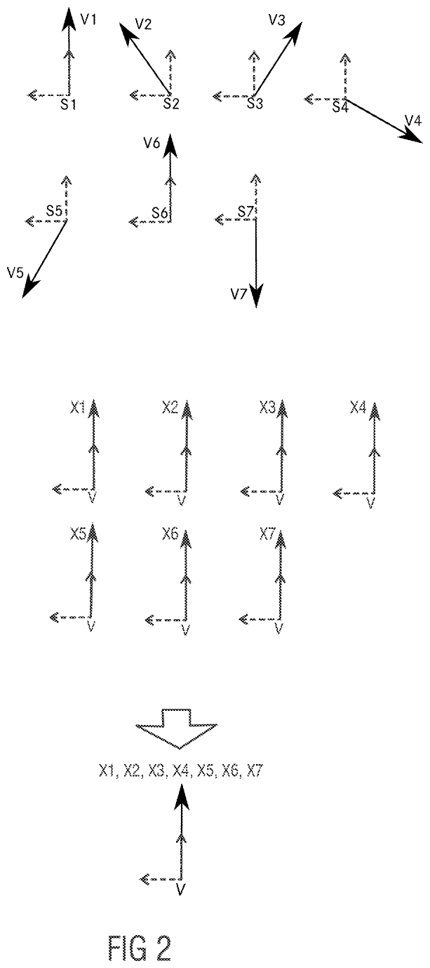

In a method referred to as an extrinsic calibration and known from the prior art, a uniform coordinate transformation is identified once for each of the sensor coordinate systems S1 to S7, and is subsequently used for the transformation of a relative speed V1 to V7 in the vehicle coordinate system V which is detected with the respective sensor, as is shown in more detail in FIG. 2.

FIG. 2 shows the first to seventh relative speed V1 to V7 detected by each sensor as a two-dimensional vector magnitude in the respectively associated sensor coordinate system S1 to S7 in a uniform, straight movement of the vehicle 1. Due to their rotation relative to each other, the second to fifth as well as the seventh relative speed V2 to V5, V7 have a different direction and partially also a different magnitude in the second to fifth as well as in the seventh sensor coordinate systems S2 to S5, S7.

By means of applying the sensor-related uniform coordinate transformation, an estimated object speed X1 to X7 is respectively identified for every relative speed V1 to V7, which indicates the estimated speed of the respective sensor according to magnitude and direction, based on the vehicle coordinate system V.

If the sensor-related uniform coordinate transformations have been correctly identified in the extrinsic calibration, and if the sensor coordinate systems S1 to S7 are unchanged in their position relative to each other and to the vehicle 1, then an object speed X1 to X7 that is the same according to magnitude and direction is identified based on the vehicle coordinate system V during a straight, uniform movement of the vehicle 1 by means of applying the sensor-related uniform coordinate transformation to all of the relative speeds V1 to V7, as shown in FIG. 2.

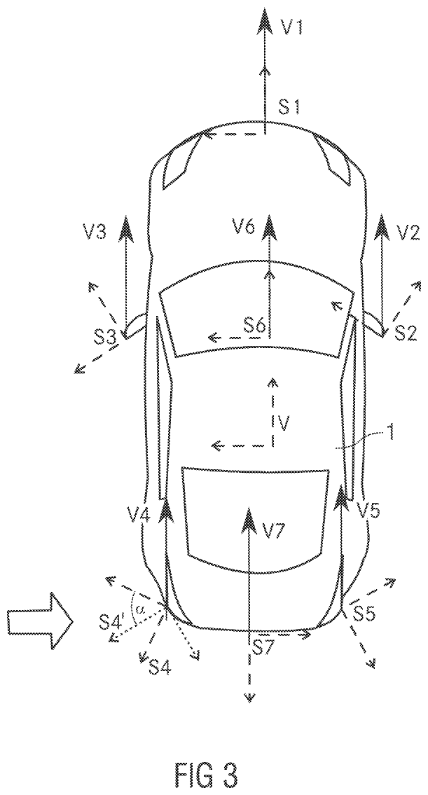

FIG. 3 shows the vehicle 1 with its sensor coordinate systems S1 to S7 associated with the sensors not shown in more detail. Contrary to FIG. 1, the fourth sensor coordinate system S4 is changed compared to the state in which the extrinsic calibration was carried out.

In particular, the fourth sensor coordinate system S4 is rotated around an angular offset a compared to an originally calibrated fourth sensor coordinate system S4′, with which the extrinsic calibration was carried out.

Similarly, if the vehicle 1 is moved in the same manner as is indicated by the relative speeds V1 to V7 according to FIG. 2, the fourth relative speed V4 also rotates in the fourth sensor coordinate system S4, while the remaining relative speeds V1 to V3, V5 to V7 remain unchanged according to magnitude and direction compared to FIG. 2.

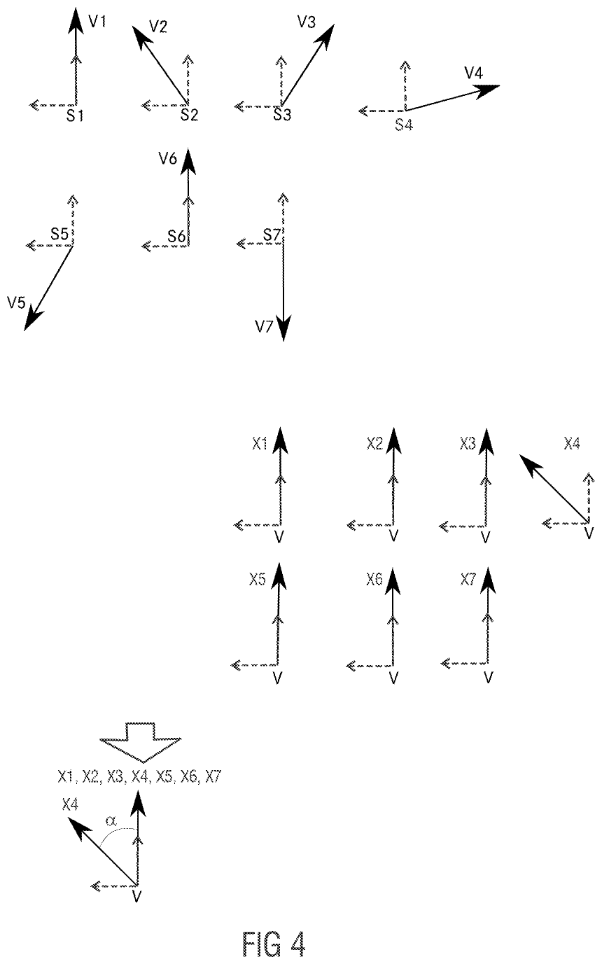

The application of the sensor-related uniform coordinate transformations for these remaining relative speeds V1 to V3, V5 to V7 thus causes object speeds X1 to X3, X5 to X7 that match respectively to each other and also to the movement of the vehicle 1, as shown in FIG. 4.

The angular offset a of the fourth sensor coordinate system S4 compared to the extrinsic calibration, however, also causes an angular offset a of the fourth object speed X4, which is identified by means of applying the uniform coordinate transformation based on the originally calibrated fourth sensor coordinate system S4′.

The invention is based on the knowledge that a positional deviation of a sensor coordinate system S4 compared to an original sensor coordinate system S4′ can be recognized at the time of the extrinsic calibration from the deviation of a single—here the fourth—object speed X4 compared to a plurality of other object speeds X1 to X3, X5 to X7, that match with each other.

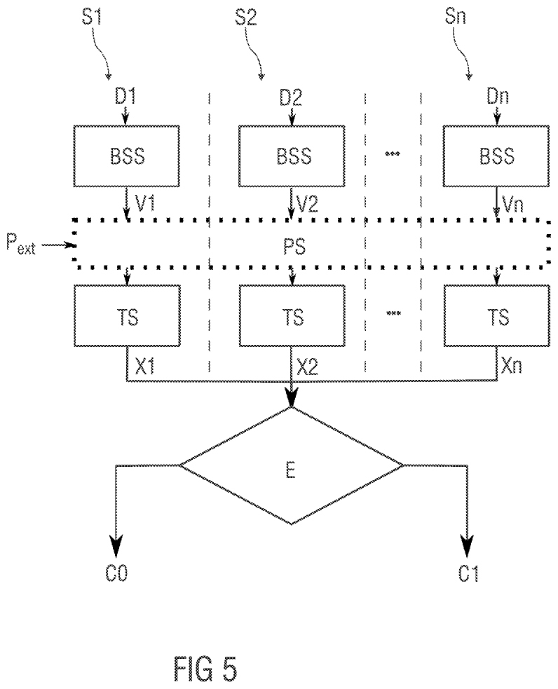

FIG. 5 explains the process of a method for recognizing such a positional deviation.

For the first to nth sensor coordinate system S1 to Sn, a first to nth relative speed V1 to Vn is estimated from respectively associated sensor data D1 to Dn in a movement estimation step BSS. For example, a relative speed V1 to Vn can be estimated from the local movement of an object in the sensor coordinate system S1 to Sn.

From the plurality of relative speeds V1 to Vn estimated in this way, a movement model of the vehicle 1 is parameterized in a subsequent parameterization step PS.

In the parameterization step PS, additionally to the estimated relative speeds V1 to Vn respectively based on a sensor coordinate system S1 to Sn, extrinsic parameters Pₑₓₜ are incorporated, which describe the location of the sensor coordinate system S1 to Sn based on the vehicle coordinate system V (and thus also their location relative to each other). For example, the extrinsic parameters Pₑₓₜ can be provided as parameters of all uniform coordinate transformations, which describe the position (i.e., the offset and the rotation) respectively of a sensor coordinate system S1 to Sn relative to the vehicle coordinate system V. The extrinsic parameters Pₑₓₜ are defined in an extrinsic calibration carried out in advance according to methods which are known from the prior art.

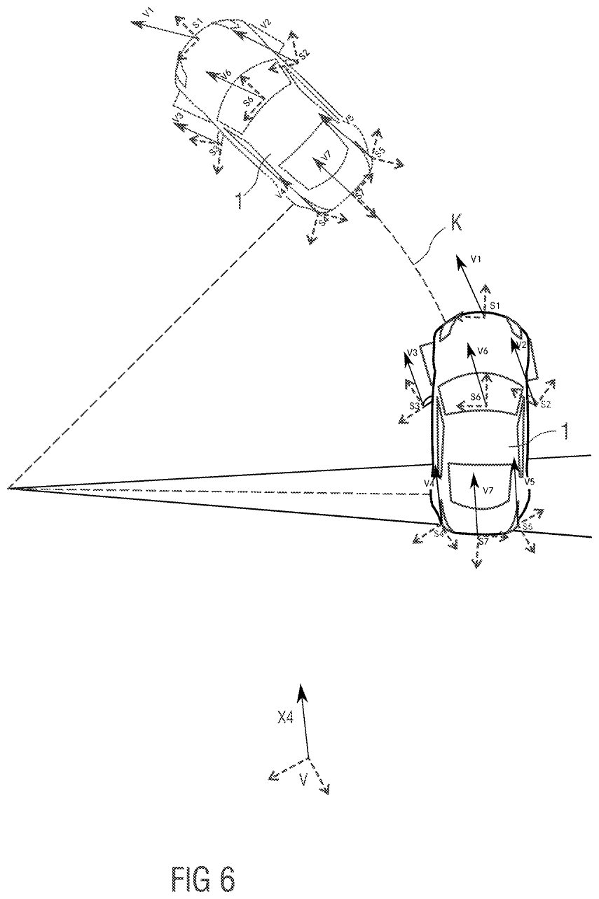

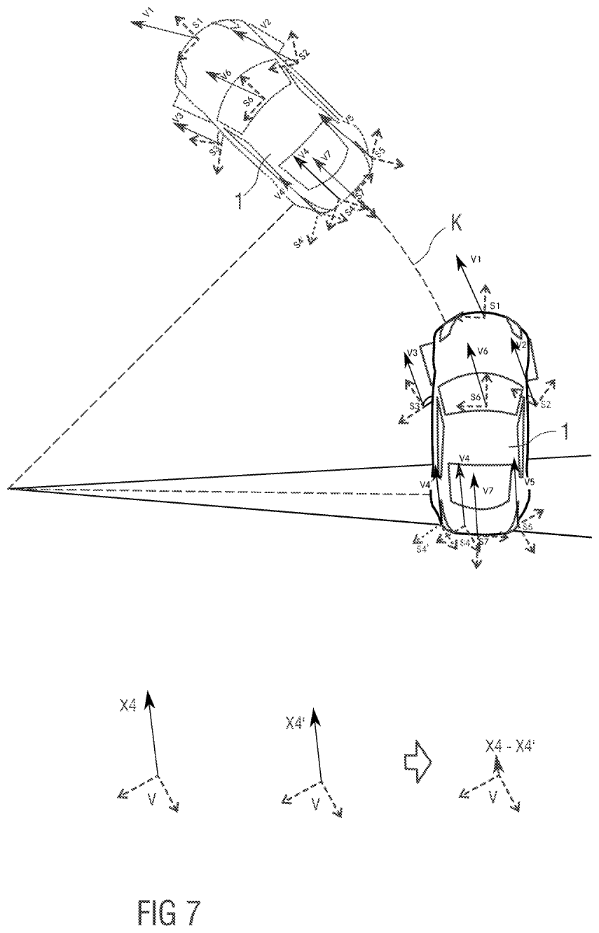

The parameterizable movement model of the vehicle 1 comprises, for example, a speed component along a longitudinal direction of the vehicle 1 during a straight movement. The parameterizable movement model optionally comprises, for example when cornering, a further speed component along a transverse direction of the vehicle 1 arranged perpendicular to the longitudinal direction. Alternatively or additionally, a parameterizable movement model can, during cornering, also comprise a radius of curvature of a vehicle trajectory K, as is explained in the following based on FIGS. 6 and 7. Further vehicle-kinematic parameters can also be detected in the parameterized movement model.

In a subsequent transformation step TS, again performed separately relative to all of the sensor coordinate systems S1 to Sn, an object speed X1 to Xn is respectively identified for all of the first to nth relative speeds V1 to Vn, by means of applying the parameterizable movement model. An object speed X1 to Xn indicates, according to direction and magnitude, a speed which the respective sensor has, based on the vehicle coordinate system V, matching the movement model identified in the parameterization step PS, if the respective sensor is unchanged in its position based on the vehicle coordinate system V compared to the extrinsic calibration.

In a following deciding step E, the object speeds X1 to Xn are compared among each other and/or the respectively identified object speed X1 to Xn is compared with the respectively defined relative speed for each of the sensor coordinate systems S1 to Sn.

In one embodiment, object speeds X1 to Xn that differ especially noticeably from the majority of the remaining identified object speeds X1 to Xn are recognized as outliers. Methods for recognizing outliers are known from the prior art. For example, an average and a standard deviation can be defined from the sum of the object speeds X1 to Xn. An object speed X1 to Xn can then be recognized as an outlier if it differs from the average by a multiple of the standard deviation.

If one or several such outliers are recognized, then, subsequently to the deciding step E, a decalibrated state C0 is assigned as the result, which shows that vehicle positions of the vehicle 1 which are identified based on the sensor data D1 to Dn are not reliable.

If no outliers are recognized among the identified object speeds X1 to Xn, then, subsequently to the deciding step E, a calibrated state C1 is assigned as the result, which shows that vehicle positions which are identified based on this sensor data D1 to Dn are still reliable.

A trustworthiness (or reliability) of the identification of vehicle positions can thereby be defined, without reference measurements of several sensor coordinate systems S1 to Sn in relation to a shared reference object being necessary. In particular it does not have to be detected or ensured whether or that the same reference object is measured by several or even all sensor coordinate systems S1 to Sn. It is therefore not necessary to identify a reference object. In particular, it is also not necessary to detect such reference objects in a digital map or and compare measurements in the sensor coordinate system S1 to Sn with a digital map.

Alternatively or additionally, the average square distance of the object speeds X1 to Xn can be identified from an average (vectorial) object speed as amount for the matching of the current positional relationships of the sensor coordinate systems S1 to Sn with those at the time of the extrinsic calibration.

If the average square distance (or a similar distance measure for the object speeds X1 to Xn) exceeds a predetermined threshold value, then, subsequently to the deciding step E, a decalibrated state C0 is assigned as the result, which shows that vehicle positions of the vehicle 1, which are identified based on the sensor data D1 to Dn, are not reliable. In other cases, a calibrated state C1 is subsequently assigned to the decision step E as the result, which shows that vehicle positions identified based on this sensor data D1 to Dn are still reliable.

An advantage of this embodiment is that the decalibration of even several sensors can be defined more reliably than with methods of outlier detection.

The distance measure can also be defined as a relative distance in relation to an average object speed, for example as a variation coefficient of the magnitudes of the object speeds X1 to Xn. An advantage of this embodiment is that a more robust recognition of a decalibrated state C0 is possible.

FIGS. 6 and 7 illustrate the method in its application in a vehicle 1, which is moved along a vehicle trajectory K, which is formed as a circular segment.

FIG. 6 shows the vehicle 1 of FIG. 1 when cornering with sensor coordinate systems S1 to S7 that are unchanged compared to the extrinsic calibration. By means of applying the identified uniform coordinate transformation to the measured fourth relative speed V4 in the extrinsic calibration for the fourth sensor coordinate system S4, a fourth object speed X4 in relation to the vehicle coordinate system V is identified.

FIG. 7 shows a vehicle 1 that is changed in comparison, in which the fourth sensor coordinate system S4 is indeed orientated the same, but is moved, relative to the calibrated fourth sensor coordinate system S4′. Such a movement causes no change in the measured fourth relative speed V4 during a straight movement of the vehicle 1, and therefore also no deviation in the fourth object speed X4. In other words: a pure movement of a sensor coordinate system S4 cannot be determined during a straight movement by means of a comparison of the object speeds X1 to X7, which are defined by means of applying the uniform coordinate transformations.

If the vehicle 1 is, however, as shown in FIG. 7, moved in a circular segment-shaped vehicle trajectory K, then the fourth sensor coordinate system S4, which moved in the direction of the longitudinal central axis of the vehicle and thus away from the centre of curvature of the vehicle trajectory K, experiences a higher radial speed than the originally calibrated fourth sensor coordinate system S4′ would experience.

Consequently, a fourth object speed X4 is also identified by means of applying the extrinsically calibrated uniform coordinate transformation. This is indeed not changed in direction, rather in amount (in the present example: increased) compared to the fourth object speed X4′ in the calibrated position.

This difference can be detected both by means of comparison of the identified fourth object speed X4 with the remaining object speeds X1 to X3, X5 to X7 (which match in amount with the fourth object speed X4′ in the calibrated position) or with at least one statistical amount derived from the sum of all object speeds X1 to X7, as has already been explained using FIG. 5.

A pure offset of a sensor coordinate system S4 is therefore also recognizable with the proposed method compared to the position in which the extrinsic calibration has been carried out. An advantage of this method is thus that an extrinsic calibration can be reliably validated, without it being necessary to measure an identical reference object with several sensor coordinate systems S1 to S7. The reliability of identifying a vehicle position by means of independent sensors can thereby be improved.

1.-6. (canceled)

7. A method for validating a plurality of environment detection sensors that are rigidly connected with a vehicle (1), wherein the plurality of environment detection sensors are configured for detecting a relative speed (V1 to V7, Vn), which is based on a sensor coordinate system (S1 to S7, Sn) of a respective environment detection sensor, of an object detected in the environment of the vehicle (1), comprising:
in an extrinsic calibration, a uniform coordinate transformation for converting coordinates of the sensor coordinate system (S1 to S7, Sn) into coordinates of a vehicle coordinate system (V) that is rigidly connected with the vehicle (1) is defined for every sensor coordinate system (S1 to S7, Sn);
using the uniform coordinate transformations:
an object speed (X1 to X7, Xn) is defined for every relative speed (V1 to V7, Vn) based on the vehicle coordinate system (V); and/or
at least one parameter of a movement model of the vehicle (1) is defined from the plurality of the relative speeds (V1 to V7, Vn); and
a decalibrated state (C0) is then assigned to the plurality of environment detection sensors when the object speeds (X1 to X7, Xn) deviate from each other and/or relative to the movement model of the vehicle (1) by more than a predetermined amount.

8. The method according to claim 7, wherein deviations of the object speeds (X1 to X7, Xn) are defined as pairwise vector differences and a maximum pairwise vector difference according to magnitude and/or direction is compared with a predetermined difference in magnitude or a predetermined difference in angle.

9. The method according to claim 7, wherein:
as the movement model of the vehicle (1), a vehicle speed based on the vehicle coordinate system (V) is defined according to magnitude and direction;
a target relative speed is identified from the vehicle speed according to the respective associated uniform coordinate transformation for every sensor coordinate system (S1 to S7, Sn); and
at least one target relative speed is compared with the relative speed (V1 to V7, Vn) detected for the respective sensor coordinate system (S1 to S7, Sn) according to magnitude and/or direction.

10. The method according to claim 7, wherein a reliability of the association of the decalibrated state (C0) and/or a reliability of the association of a complementary calibrated state (C1) is statistically identified from the plurality of relative speeds (V1 to V7, Vn).

11. A vehicle (1), comprising:
a computing unit; and
a plurality of environment detection sensors, wherein the plurality of environment detection sensors are configured for detecting a relative speed (V1 to V7, Vn), which is based on a sensor coordinate system (S1 to S7, Sn) of a respective environment detection sensor, of an object detected in the environment of the vehicle (1);
wherein the plurality of environment detection sensors and the computing unit are configured for performing the method according to claim 7.

12. The vehicle (1) according to claim 11, wherein the computing unit is a control unit.
